(19) United States
(12) Patent Application Publication
(10) Pub. No.: US 2012/0123657 A1
(43) Pub. Date: May 17, 2012

(54) VEHICLE SPEED CONTROL SYSTEM

(75) Inventor: Kiyotaka Taguchi, Kariya-city (JP)

(73) Assignee: DENSO CORPORATION, Kariya-city (JP)

(21) Appl. No.: 13/293,444

(22) Filed: Nov. 10, 2011

(30) Foreign Application Priority Data
Nov. 12, 2010 (JP) 2010-253933

(51) Int. Cl. B60K 31/00; G01C 21/34

(52) U.S. Cl. 701/93

(57) ABSTRACT

A subject vehicle runs under a fixed speed travel at a target speed by an auto-cruise system. When it is determined that the subject vehicle cannot arrive at a destination using a present residual fuel quantity, a navigation apparatus is caused to retrieve an eco-route. It is then determined whether the subject vehicle can arrive at the destination by running the eco-route at a fuel-efficient speed which can consume fuel efficiently using the present residual fuel quantity. When it is determined that the subject vehicle can arrive, the fuel-efficient speed is presented as a recommended speed. Thus, a driver of the subject vehicle is urged to designate the fuel-efficient speed as a new target speed for the auto-cruise control.

### CROSS REFERENCE TO RELATED APPLICATION

The present application is based on and incorporates herein by reference Japanese Patent Application No. 2010-253933 filed on Nov. 12, 2010.

### FIELD OF THE INVENTION

The present invention relates to a vehicle speed control system which maintains a vehicle speed of a subject vehicle at a fixed speed.

### BACKGROUND OF THE INVENTION

[Patent document 1]: JP-2008-189055 A

There is known an auto-cruise which saves time and effort for an accelerator operation of a driver by carrying out an automatic control for a vehicle speed of the subject vehicle. The auto-cruise performs an automatic control of the vehicle speed so as to maintain a target speed set by a driver, or so as to maintain an inter-vehicle distance with a traveling vehicle ahead of the subject vehicle, as described in Patent document 1. Further, in Patent document 1, the inter-vehicle distance with the traveling vehicle ahead of the subject vehicle is designated based on the inter-vehicle distances with traveling vehicles on the right/left or back of the subject vehicle; the vehicle speed of the subject vehicle is adjusted automatically so as to maintain the designated inter-vehicle distance. This can achieve a suitable inter-vehicle distance with the traveling vehicle ahead according to peripheral states and reduce a driving fatigue of the driver.

Thus, in the conventional auto-cruise, the vehicle speed is designated by the instruction of the driver or according to the vehicles which run near the subject vehicle. However, the vehicle speed is not designated in consideration of a residual quantity of the fuel of the subject vehicle, or weather states in a vicinity of the subject vehicle. Therefore, when the residual quantity of the fuel runs short, or when the weather state becomes worse, there may a possibility to poses a trouble in driving.

### SUMMARY OF THE INVENTION

It is an object of the present invention to provide a vehicle speed control system enabling driving by auto-cruise more smoothly.

To achieve the above object, according to an aspect of the present invention, a vehicle speed control system is provided as follows. The vehicle speed control system performs an automatic control of a drive apparatus that drives a vehicle to cause a vehicle speed to become a target speed so as to enable the vehicle to perform a fixed speed travel while maintaining the target speed. The vehicle speed control system includes the following: a designation section to designate a target speed according to an instruction signal from an external source; a detection section to detect a travel state of the vehicle which performs a fixed speed travel; and a presentation section to present a recommended speed of the vehicle according to the travel state detected by the detection section.

Under such a configuration, a suitable recommended vehicle speed according to the present travel state may be recognized by the driver; the driver can be caused to designate the recommended speed as the target speed under the fixed speed travel. This enables the subject vehicle to maintain the suitable speed at which the fixed speed travel is made, and enables the subject vehicle to run under the fixed speed travel more smoothly.

According to another aspect of the present invention, a method is provided for presenting a recommended speed in a vehicle speed control system for performing an automatic control of a drive apparatus that drives a vehicle to cause a vehicle speed to become a target speed so as to enable the vehicle to perform a fixed speed travel while maintaining the target speed. The method includes: designating a target speed according to an instruction signal from an external source; detecting a travel state of the vehicle which performs a fixed speed travel; and presenting a recommended speed of the vehicle according to the travel state detected by the detection section.

### BRIEF DESCRIPTION OF THE DRAWINGS

The above and other objects, features, and advantages of the present invention will become more apparent from the following detailed description made with reference to the accompanying drawings. In the drawings:

FIGS. 1A, 1B are block diagrams illustrating configurations of an auto-cruise system and a vehicle speed control apparatus, respectively, according to an embodiment of the present invention;

FIG. 2 is a flowchart diagram illustrating a fuel-efficient speed presentation process;

FIGS. 3A to 3B are diagrams illustrating examples of presentations for a recommended speed (fuel-efficient speed);

FIG. 3C is a diagram illustrating a reduction degree of fuel;

FIG. 4 is a flowchart diagram illustrating a safety speed presentation process; and

FIG. 5 is a diagram illustrating an example of a presentation for a recommended speed (safety speed).

### DETAILED DESCRIPTION OF THE PREFERRED EMBODIMENTS

An embodiment of the present invention is explained with reference to drawings. In addition, the embodiment of the present invention can be modified in various manners within a technical scope of the present invention without being limited to the following embodiment.

[Explanation of Configuration]

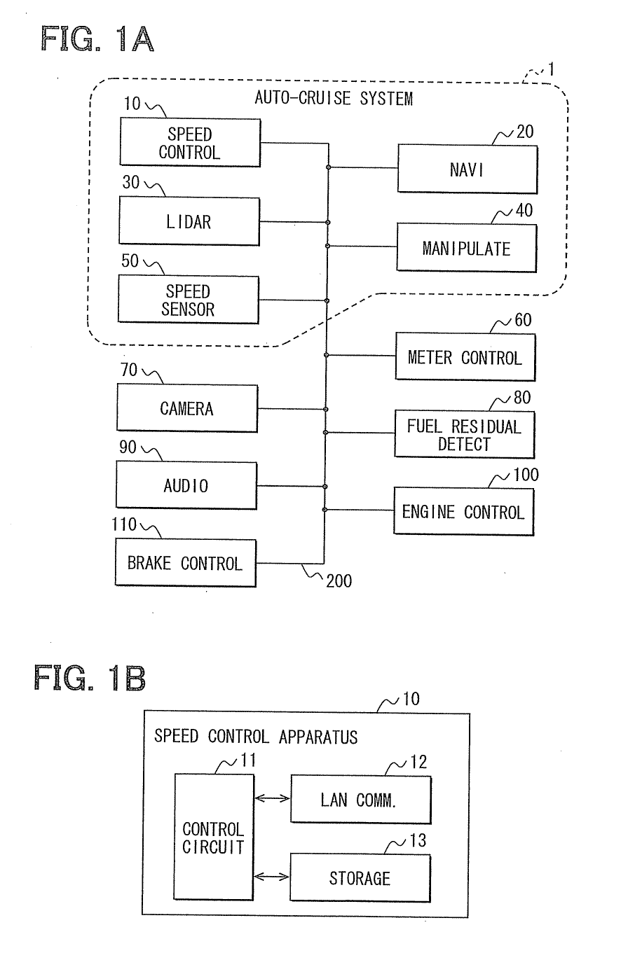

FIG. 1A is a block diagram indicating a configuration of an auto-cruise system 1 according to an embodiment of the present invention. The auto-cruise system 1 is to perform an automatic control for a vehicle speed of a subject vehicle driven by an engine which uses gasoline as a fuel. The auto-cruise system 1 performs an auto-cruise using a method of adjusting a vehicle speed automatically so as to keep constant an inter-vehicle distance with a traveling vehicle ahead of the subject vehicle or a method of maintaining a target speed designated by a driver of the subject vehicle to thereby run the subject vehicle. In addition, this auto-cruise system 1 includes the followings: a vehicle speed control apparatus 10 which controls an engine and/or a brake in order to adjust a vehicle speed of the subject vehicle; a navigation apparatus 20 which retrieves a route to a destination based on map data and executes route guidance; a laser radar 30 which may be referred to as a lidar apparatus (a laser intensity direction and ranging apparatus) and measures an inter-vehicle distance with a vehicle ahead of the subject vehicle; a manipulation portion 40 that includes a jog dial or various switches; and a vehicle speed sensor 50 which detects a vehicle speed of the subject vehicle. These are communicated with each other via an in-vehicle LAN 200.

It is noted that the in-vehicle LAN 200 is further connected with a meter control apparatus 60 which controls a meter, a camera 70 which captures an image of a vicinity or surrounding area of the subject vehicle, a fuel residual detection apparatus 80 which detects a residual quantity of fuel for the subject vehicle, a known audio 90 equipped with television and/or a radio set, an engine control apparatus 100 which controls an engine operating state, and a brake control apparatus 110 which controls an operating state of a brake.

With reference to FIG. 1A, the vehicle speed control apparatus 10 includes the following: a control circuit 11 contains a known microcomputer having a CPU, ROM, RAM, I/O, and a bus line connecting the foregoing components or the like to perform an which carries out an overall control of the vehicle speed control apparatus 10 according to a program stored in the ROM; an in-vehicle LAN communication portion 12 which executes communications with another apparatus via the in-vehicle LAN 200; and a storage portion 13 that includes a device such as a flash memory which does not need an operation to hold storage to thereby store a variety of information items.

[Explanation of Operation]

The following explains an operation of the auto-cruise system 1 at the time of performing auto-cruise (a fixed speed travel) using a method of running the subject vehicle in a state where a target speed designated by the driver is maintained.

In the case of the fixed speed travel (i.e., under a fixed speed travel), the control circuit 11 of the vehicle speed control apparatus 10 designates a target speed according to a manipulation or instruction of a driver received via the manipulation portion 40. The control circuit 11 receives a vehicle speed (i.e., a vehicle speed signal) of the subject vehicle from the vehicle speed sensor 50 via the in-vehicle LAN 200, and transmits various commands to the engine control apparatus 100 or the brake control apparatus 110, controlling the number of rotations of the engine, an operating state of the brake, and/or a change gear ratio, so as to enable the subject vehicle to maintain the traveling at a target speed.

In addition, the control circuit 11 determines whether continuing a fixed speed travel at a present target speed interferes with a travel of the subject vehicle based on a travel state such as a residual quantity of the fuel for the subject vehicle, and/or the weather in a vicinity of the subject vehicle. When determining that it interferes with the travel, the control circuit 11 presents a recommended speed and urges the driver to designate the recommended speed as the target speed. The following explains a process which presents a recommended speed according to a travel state of the subject vehicle.

(1) Fuel-Efficient Speed Presentation Process

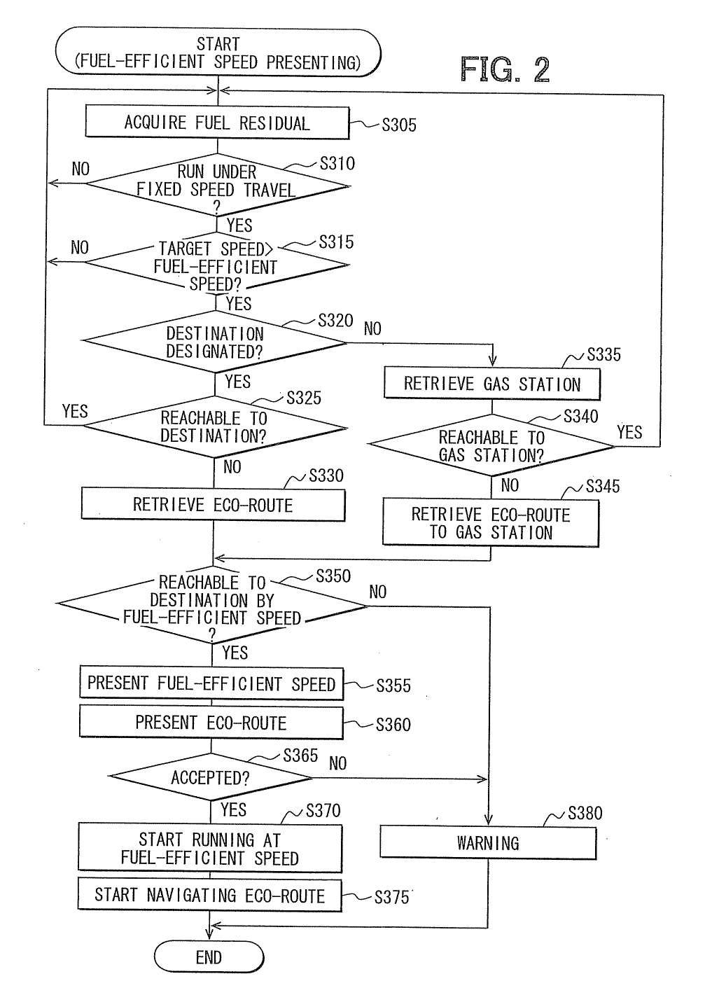

First, a fuel-efficient speed presentation process is explained which presents a recommended speed in a fixed speed travel according to a residual quantity of the fuel for the subject vehicle, with reference to a flowchart of FIG. 2. The present process is started at the time of a start up of the subject vehicle.

It is further noted that a flowchart or the processing of the flowchart in the present application includes sections (also referred to as steps), which are represented, for instance, as S305. Further, each section can be divided into several sub-sections while several sections can be combined into a single section. Furthermore, each of thus configured sections can be referred to as a device, means, module, or processor and achieved not only as a software section in combination with a hardware device but also as a hardware section. Furthermore, the software section may be included in a software program, which may be contained in a non-transitory computer-readable storage media as a program product.

At S305, the control circuit 11 of the vehicle speed control apparatus 10 of the auto-cruise system 1 acquires a residual quantity of the fuel for the subject vehicle from the fuel residual detection apparatus 80 via the in-vehicle LAN 200. The processing then advances to S310. The process executed by the control circuit 11 of the vehicle speed control apparatus 10 is explained as a process executed by the vehicle speed control apparatus 10.

At S310, the speed control apparatus 10 determines whether the subject vehicle is under a fixed speed travel. When the determination at S310 is affirmed (S310: Yes), the processing proceeds to S315. When the determination at S310 is negated (S310: NO), the processing proceeds to S305.

At S315, the vehicle speed control apparatus 10 determines whether the present vehicle speed exceeds a fuel-efficient speed. The fuel-efficient speed may be referred to as a low fuel consumption speed to enable an efficient consumption of the fuel, i.e., to increase a mileage that is a travel distance per a predetermined fuel quantity. It is noted that the fuel-efficient speed may be a vehicle speed that satisfies both of the fuel consumption efficiency and the safe and smooth travel, or may be a vehicle speed that is determined in consideration of road classes in respect of highway or local road, road width, and/or presence or absence of oncoming lane or traffic. In addition, for example, the fuel-efficient speed may be a vehicle speed range that has a predetermined range of the vehicle speed such as 30 km/h-60 km/h. When the determination at S315 is affirmed (S315: Yes), the processing proceeds to S320. When the determination at S315 is negated (S315: NO), the processing proceeds to S305.

At S320, the vehicle speed control apparatus 10 communicates with the navigation apparatus 20, and determines whether a destination for a route guidance is designated. When the determination at S320 is affirmed (S320: Yes), the processing proceeds to S325. When the determination at S320 is negated (S320: NO), the processing proceeds to S335.

At S325, the vehicle speed control apparatus 10 causes the navigation apparatus 20 to calculate a fuel consumption quantity that is consumed when the subject vehicle travels the guidance route to the destination under the fixed speed travel at the present target speed. It is noted that navigation apparatus 20 may calculate the fuel consumption quantity in consideration of slopes in the guidance route, and the number of times of temporary short stops estimated in the traveling of the guidance route. Then, the vehicle speed control apparatus 10 acquires the calculated fuel consumption quantity and determines whether the subject vehicle can reach the destination by the present residual quantity of the fuel under the fixed speed travel at the target speed. When the determination at S325 is affirmed (S325: Yes), the processing proceeds to S305. When the determination at S325 is negated (S325: NO), the processing proceeds to S330.

At S330, the vehicle speed control apparatus 10 causes the navigation apparatus 20 to retrieve an eco-route which is a route in which the fuel consumption is the smallest among those of the routes to the destination, and calculate the fuel consumption quantity consumed by traveling this eco-route under the fixed speed travel at the fuel-efficient speed.

It is noted that the navigation apparatus 20 may retrieve the eco-route in consideration of the characteristic of the subject vehicle, the road shapes, and/or the number of times of temporary short stops. In addition, as already stated, the fuel-efficient speed may be determined in consideration of the road classes the subject vehicle runs. In such a case, the fuel consumption quantity may be calculated on an assumption that the fixed speed travel is made at fuel-efficient speeds according to the road classes of the roads included in the eco-route, respectively. In addition, instead of the eco-route, for example, a time shortest route having a shortest travel time to the destination may be retrieved and the similar process may apply to the retrieved time shortest route.

Then, the processing proceeds to S350. At S335 executed when the destination is not designated, the navigation apparatus 20 is caused to retrieve a nearby gas station and designates the gas station as a destination. Then the processing advances to S340.

At S340, the vehicle speed control apparatus 10 causes the navigation apparatus 20 to retrieve routes to the nearby gas station designated as the destination and to calculate the fuel consumption quantity consumed by traveling any one of the retrieved routes under the fixed speed travel at the target speed. Then, the calculated fuel consumption quantity is acquired. It is then determined whether the subject vehicle can reach the nearby gas station by the present residual quantity of the fuel under the fixed speed travel at the present target speed. When the determination at S340 is affirmed (S340: Yes), the processing proceeds to S305. When the determination at S340 is negated (S340: NO), the processing proceeds to S345.

At S345, the vehicle speed control apparatus 10 causes the navigation apparatus 20 to retrieve an eco-route which is a route in which the fuel consumption is the smallest among those of the routes to the nearby gas station, and calculate the fuel consumption quantity consumed by traveling this eco-route under the fixed speed travel at the fuel-efficient speed. The processing then proceeds to S350.

At S350, the vehicle speed control apparatus 10 acquires the fuel consumption quantity calculated at S330 or S345, and compares the acquired fuel consumption quantity with the present residual quantity of the fuel. Thereby, it is determined whether the subject vehicle can reach the destination designated by the driver or the nearby gas station by running the eco-route under the fixed speed travel at the fuel-efficient speed. When the determination at S350 is affirmed (S350: Yes), the processing proceeds to S355. When the determination at S350 is negated (S350: NO), the processing proceeds to S380.

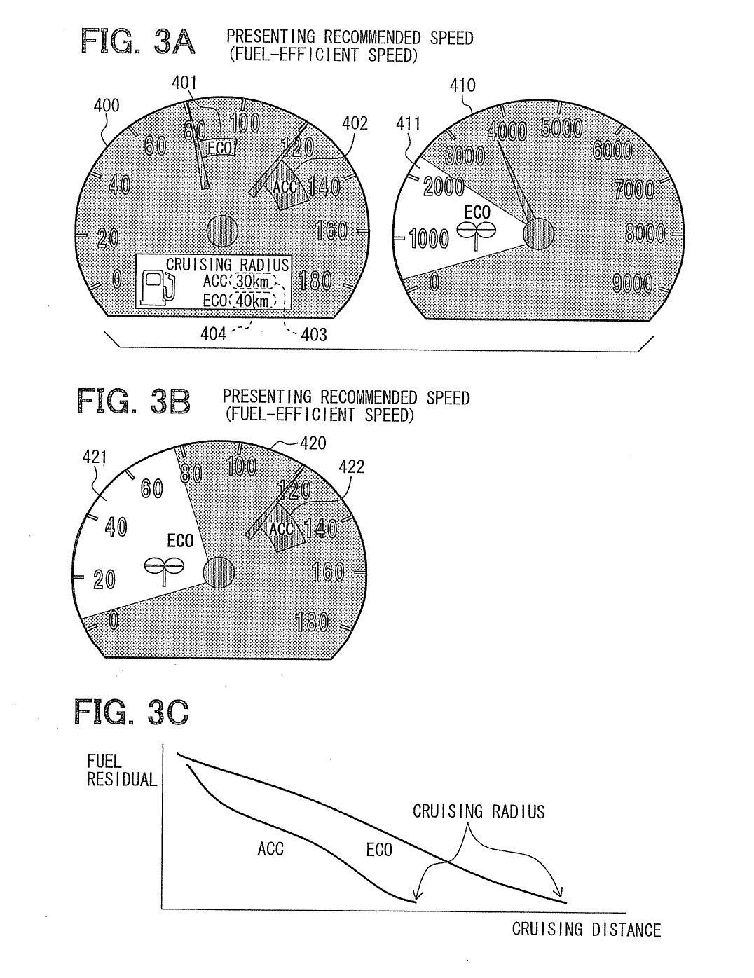

At S355, the vehicle speed control apparatus 10 presents the fuel-efficient speed as a recommended speed via the meter control apparatus 60. In detail, the vehicle speed control apparatus 10 transmits the recommended speed (i.e., the fuel-efficient speed) and the present target speed to the meter control apparatus 60. As illustrated in FIG. 3A, the recommended speed 401 and the present target speed 402 of the auto-cruise control may be displayed in the LCD provided in the speed meter panel 400 as “ECO” and “ACC”, respectively. Further, a range 411 of the engine speed value that enables the travel in the state where the fuel consumption is suppressed may be displayed in the LCD provided in the tachometer panel 410. In addition, a cruising radius 403 under the fixed speed travel at the present target speed and a cruising radius 404 under the fixed speed travel at the recommended speed may be displayed in a lower portion of the LCD provided in the speed meter panel 400.

In addition, as illustrated in FIG. 3B, the recommended speed 421 and the present target speed 422 may be displayed in the LCD provided in the speed meter panel 420. It is noted that FIG. 3A presents an example which displays a fuel-efficient speed at the time of running a highway as a recommended speed. In contrast, FIG. 3B presents an example which displays a fuel-efficient speed at the time of running a local road as a recommended speed. In addition, the recommended speed may be presented using a display or an audio of the navigation apparatus 20.

The processing then proceeds to S360. At S360, the vehicle speed control apparatus 10 causes the navigation apparatus 20 to display the eco-route that is retrieved at S330 or S345. In this case, the vehicle speed control apparatus 10 transmits the following to the navigation apparatus 20: a present residual quantity of the fuel; a fuel-efficient speed; a target speed; and a fuel efficiency (i.e., mileage) of the subject vehicle. Thereby, the navigation apparatus 20 is caused to calculate a reduction degree of the fuel versus the travel distance at the time of running the eco-route under the fixed speed travel at the fuel-efficient speed, and a reduction degree of the fuel versus the travel distance at the time of running the eco-route under the fixed speed travel at the target speed. The display of the navigation apparatus 20 illustrates a graph which indicates the reduction degree of the fuel versus the travel distance at the time of running the eco-route under the fixed speed travel at the fuel-efficient speed, and the reduction degree of the fuel versus the travel distance at the time of running the eco-route under the fixed speed travel at the target speed (FIG. 3C). After displaying this graph, the vehicle speed control apparatus 10 advances the processing to S365.

At S365, the vehicle speed control apparatus 10 determines whether a recommended speed (i.e., fuel-efficient speed) is newly designated as a target speed according to a manipulation or instruction signal received via the manipulation portion 40. When the determination at S365 is affirmed (S365: Yes), the processing proceeds to S370. When the determination at S365 is negated (S365: No), the processing proceeds to S380.

At S370, the vehicle speed control apparatus 10 starts the fixed speed travel at the recommended speed (fuel-efficient speed) designated as the target speed. At S375, the navigation apparatus 20 is caused to start a route guidance of the eco-route (S375). Then, the present process is ended.

At S380 executed when it is determined that the subject vehicle cannot reach the destination even under the fixed speed travel at the recommended speed or when the recommended speed (fuel-efficient speed) is not designated as a target speed, the vehicle speed control apparatus 10 executes a warning about a danger of being out of fuel (i.e., fuel shortage) before arriving at the destination, via the navigation apparatus 20 or the meter control apparatus 60. The present process is then ended.

(2) Safety Speed Presentation Process

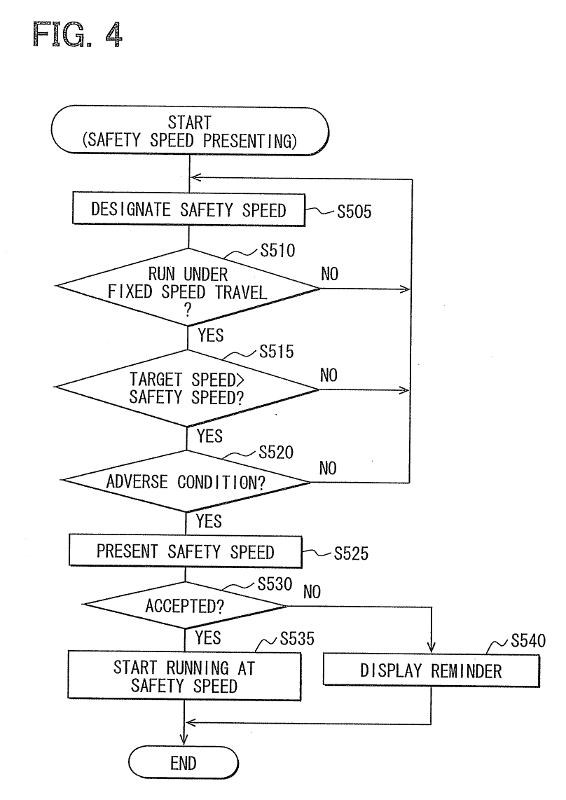

The following explains a safety speed presentation process which presents a recommended speed in the fixed speed travel according to an environment of surrounding the subject vehicle, such as a present weather state, a surface state of a road under travel, and a visual field of a driver, with reference to a flowchart of FIG. 4. The present process is started at the time of a start up of the subject vehicle.

At S505, the speed control apparatus 10 of the auto-cruise system 1 detects a present weather state, a road surface state of a road under travel, and a visual field of the driver, and designates a safety speed according to the detection result.

In specific, the vehicle speed control apparatus 10 may detect the weather state based on an image of a vicinity of the subject vehicle captured by the camera 70, for example. It may detect a weather state using traffic information acquired from a digital radio broadcast which is received by the audio 90. It may detect a weather state using a raindrop sensor, a temperature sensor, and/or a humidity sensor (none shown). Then the safety speed may be designated according to the weather state.

In addition, for example, the state of the road surface such as presence or absence of the road surface freezing, moisture condition of the road surface, presence or absence of pavement of the road surface is detected based on the above-mentioned weather state and/or the image captured by the camera 70. Then the safety speed may be designated according to the road surface state. In addition, the visual field of the driver may be detected based on the above-mentioned weather state, the luminance in a vicinity of the subject vehicle detected by a luminance sensor (unshown), and the present time zone. Then the safety speed may be designated according to the visual field. In addition, the safety speed may be designated by determining comprehensively the visual field of the driver, the weather state, and the state of the road surface.

It is noted that the safety speed may be a vehicle speed that enables a safe and smooth travel, or may be a vehicle speed that is determined in consideration of road classes in respect of highway or local road, road width, and/or presence or absence of oncoming traffic or lane. In addition, for example, the safety speed may be a vehicle speed range that has a predetermined range of the vehicle speed such as 30 km/h-60 km/h. The processing then proceeds to S510.

At S510, the vehicle speed control apparatus 10 determines whether the subject vehicle is under a fixed speed travel of the auto-cruise control. When the determination at S510 is affirmed (S510: Yes), the processing proceeds to S515. When the determination at S510 is negated (S510: NO), the processing proceeds to S505.

At S515, the vehicle speed control apparatus 10 determines whether the present target speed exceeds the safety speed. When the determination at S515 is affirmed (S515: Yes), the processing proceeds to S520. When the determination at S515 is negated (S515: NO), the processing proceeds to S505.

At S520, the vehicle speed control apparatus 10 determines whether a deterioration of the weather state, a poor road surface, or a deterioration of the visual field arises (i.e., whether an adverse condition arises) based on the detection result at S505. When the determination at S520 is affirmed (S520: Yes), the processing proceeds to S525. When the determination at S520 is negated (S520: NO), the processing proceeds to S505.

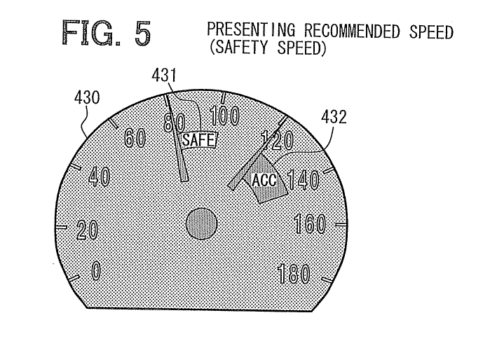

At S525, the vehicle speed control apparatus 10 presents the safety speed as a recommended speed via the meter control apparatus 60. In specific, the vehicle speed control apparatus 10 transmits the safety speed and the present target speed to the meter control apparatus 60. In addition, as illustrated in FIG. 5, the safety speed 431 (“SAFE”) and the present target speed 432 (“ACC”) of the auto-cruise control may be displayed in the LCD provided in the speed meter panel 430. The processing then proceeds to S530.

At S530, the vehicle speed control apparatus 10 determines whether the recommended speed (i.e., safety speed) is newly designated as a target speed according to a manipulation or instruction signal received via the manipulation portion 40. When the determination at S530 is affirmed (S530: Yes), the processing proceeds to S535. When the determination at S530 is negated (S530: No), the processing proceeds to S540.

At S535, the vehicle speed control apparatus 10 starts the fixed speed travel at the recommended speed (i.e., safety speed) designated as the target speed. The present process is then ended. In contrast, at S540, the vehicle speed control apparatus 10 presents a reminder or a warning via the navigation apparatus 20 and the meter control apparatus 60. The remainder or warning indicates that a risk which interferes with the driving may arise if continuing the fixed speed travel at the present target speed because of the deterioration of the peripheral environment (i.e., adverse condition) of the subject vehicle. The present process is then ended.

[Effect]

According to the auto-cruise system 1 according to the present embodiment, when the fuel residual quantity falls and the arrival at the destination under the fixed speed travel at the present target speed thus becomes difficult, the driver can be made to recognize a fuel-efficient speed and be able to designate the fuel-efficient speed as a new target speed. This configuration can help prevent an occurrence of a risk that a fuel shortage arises during the driving under the fixed travel speed to thereby cause the subject vehicle to be stalled or stopped.

In addition, the recommended speed may be presented to the driver according to an environment with respect to a vicinity of the subject vehicle, such as a weather state, a road surface state, a visual field of the driver. This recommended speed can be designated as a target speed. Therefore, even if the surrounding environment of the subject vehicle becomes worse, the fixed speed travel can be executed smoothly.

### Other Embodiments

(1) The auto-cruise system 1 of the present embodiment includes the speed control apparatus 10, the navigation apparatus 20, the manipulation portion 40, and the vehicle speed sensor 50, all of which are provided as separate independent apparatuses, individually. Without need to be limited thereto, those apparatuses can be provided to be combined as one apparatus. Even such a configuration can provide the same effect.

(2) In addition, the auto-cruise system 1 of the present embodiment is mounted in a vehicle driven with the engine which uses the gasoline as fuel. Without need to be limited thereto, for example, it may be mounted in an electric vehicle, a hybrid vehicle, or the like. When the auto-cruise system 1 is mounted in the electric vehicle, a recommended speed may be presented according to a residual quantity of a battery for supplying an electric power to a motor driving the electric vehicle, instead of the residual quantity of the fuel such as a gasoline. Further, when the auto-cruise system 1 is mounted in the hybrid vehicle, a recommended speed may be presented according to a residual quantity of the fuel of the engine and a residual quantity of a battery for supplying an electric power to a motor driving the hybrid vehicle. Even such a configuration can provide the same effect.

[Functions and Correspondence]

The auto-cruise system 1 may be referred to as a vehicle speed control system. The engine of the vehicle containing the auto-cruise system 1 may be referred to as a drive apparatus. The fuel for the engine may be referred to as an energy. In addition, the vehicle speed control apparatus 10 or the control circuit 11 of the vehicle speed control apparatus 10 may be referred to as a designation section, device, or means. The navigation apparatus 20 may be referred to as a travel route specification section, device, or means, and an eco-route specification section, device, or means. The driver of the subject vehicle may function as an external source.

In addition, the residual quantity of the fuel for the subject vehicle, and the peripheral environment of the subject vehicle (the weather state, the state of the road surface of the road under travel, the visual field of the driver) may be referred to as a travel state. In addition, S305 of the fuel-efficient speed presentation process, and S505 of the safety speed presentation process, which are executed by the control circuit 11 of the vehicle speed control apparatus 10, may be referred to as a detection section, device, or means. S355, S360, S375 of the fuel-efficient speed presentation process, and S525 of the safety speed presentation process, which are executed by the control circuit 11 of the vehicle speed control apparatus 10, may be referred to as a presentation section, device, or means.

In addition, S325, S340 of the fuel-efficient speed presentation process, which are executed by the control circuit 11 of the vehicle speed control apparatus 10, may be referred to as an arrival determination section, device, or means. S350 of the fuel-efficient speed presentation process, which is executed by the control circuit 11 of the vehicle speed control apparatus 10, may be referred to as an eco-route determination section, device, or means. S360 of the fuel-efficient speed presentation process, which is executed by the control circuit 11 of the vehicle speed control apparatus 10, may be referred to as a reduction degree calculation section, device, or means. S380 of the fuel-efficient speed presentation process, which is executed by the control circuit 11 of the vehicle speed control apparatus 10, may be referred to as a warning section, device, or means.

It will be obvious to those skilled in the art that various changes may be made in the above-described embodiments of the present invention. However, the scope of the present invention should be determined by the following claims.

What is claimed:

1. A vehicle speed control system performing an automatic control of a drive apparatus that drives a vehicle to cause a vehicle speed to become a target speed so as to enable the vehicle to perform a fixed speed travel while maintaining the target speed,
the vehicle speed control system comprising:
a designation section to designate a target speed according to an instruction signal from an external source;
a detection section to detect a travel state of the vehicle which performs a fixed speed travel; and
a presentation section to present a recommended speed of the vehicle according to the travel state detected by the detection section.

2. The vehicle speed control system according to claim 1, wherein:
the detection section detects, as the travel state, a residual quantity of an energy of the drive apparatus provided in the vehicle; and
the presentation section presents a fuel-efficient speed, which is a vehicle speed to enable an efficient consumption of the energy, in cases that the residual quantity of the energy is reduced.

3. The vehicle speed control system according to claim 2, further comprising:
a travel route specification section to specify a travel route to a destination of the vehicle based on map data; and
an arrival determination section to determine whether the vehicle is enabled to arrive at the destination under the fixed speed travel at a present target speed using the residual quantity of the energy detected by the detection section based on the travel route specified by the travel route specification section,
wherein the presentation section presents the fuel-efficient speed as the recommended speed in cases that the residual quantity of the energy is reduced to an extent that the arrival determination determines that the vehicle is not enabled to arrive at the destination.

4. The vehicle speed control system according to claim 3, wherein
the destination is designated by a driver of the vehicle.

5. The vehicle speed control system according to claim 3, wherein
the destination is a spot where the energy is re-supplied to the vehicle.

6. The vehicle speed control system according to claim 3, further comprising:
an eco-route specification section to specify, based on the map data, an eco-route, which is a route that provides a minimal consumption of the energy in a travel up to the destination,
wherein the presentation section further presents the eco-route.

7. The vehicle speed control system according to claim 6, further comprising:
an eco-route determination section to determine whether the vehicle is enabled to arrive at the destination under the fixed speed travel at the fuel-efficient speed using the residual quantity of the energy detected by the detection section based on the eco-route specified by the eco-route specification section; and
a warning section to perform a warning in cases that the eco-route determination section determines that the vehicle is not enabled to arrive at the destination.

8. The vehicle speed control system according to claim 7, wherein
the presentation section presents the fuel-efficient speed as the recommended speed in cases that the residual quantity of the energy is reduced to an extent that the arrival determination determines that the vehicle is not enabled to arrive at the destination under the fixed speed travel at the present target speed using the residual quantity of the energy, but simultaneously that the eco-route determination section determines that the vehicle is enabled to arrive at the destination under the fixed speed travel at the fuel-efficient speed using the residual quantity of the energy.

9. The vehicle speed control system according to claim 3, further comprising:
a reduction degree calculation section to calculate a first reduction degree of the energy under the fixed speed travel at the target speed, and a second reduction degree of the energy under the fixed speed travel at the fuel-efficient speed,
wherein the presentation section further presents the calculated first reduction degree relative to the fixed speed travel at the target speed and the calculated second reduction degree relative to the fixed speed travel at the fuel-efficient speed.

10. The vehicle speed control system according to claim 1, wherein
the detection section detects as the travel state a weather state in a vicinity of the vehicle.

11. The vehicle speed control system according to claim 1, wherein
the detection section detects as the travel state a road surface state of a road the vehicle runs.

12. The vehicle speed control system according to claim 1, wherein
the detection section detects as the travel state a visual field in a vicinity of the vehicle.

13. The vehicle speed control system according to claim 2, wherein
the travel state detected by the detection section further includes a weather state in a vicinity of the vehicle.

14. The vehicle speed control system according to claim 2, wherein
the travel state detected by the detection section further includes a road surface state of a road the vehicle runs.

15. The vehicle speed control system according to claim 2, wherein
the travel state detected by the detection section further includes a visual field in a vicinity of the vehicle.

16. The vehicle speed control system according to claim 3, wherein
the travel state detected by the detection section further includes a weather state in a vicinity of the vehicle.

17. The vehicle speed control system according to claim 3, wherein
the travel state detected by the detection section further includes a road surface state of a road the vehicle runs.

18. The vehicle speed control system according to claim 3, wherein
the travel state detected by the detection section further includes a visual field in a vicinity of the vehicle.

19. A method for presenting a recommended speed in a vehicle speed control system for performing an automatic control of a drive apparatus that drives a vehicle to cause a vehicle speed to become a target speed so as to enable the vehicle to perform a fixed speed travel while maintaining the target speed,
the method comprising:
designating a target speed according to an instruction signal from an external source;
detecting a travel state of the vehicle which performs a fixed speed travel; and
presenting a recommended speed of the vehicle according to the travel state detected by the detection section.
